(19) United States
(12) Patent Application Publication
(10) Pub. No.: US 2007/0104081 A1
(43) Pub. Date: May 10, 2007

(54) Recording sheet

(76) Inventors: Katsumi Moronuki, Tokyo (JP); Kenji Ikegami, Ihara-gun (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/591,917

(22) Filed: Nov. 2, 2006

(30) Foreign Application Priority Data
Nov. 7, 2005 (JP) P2005-321993

(51) Int. Cl. G11B 7/24

(52) U.S. Cl. 369/275.1

(57) ABSTRACT

A recording sheet comprising a first layer having at least a first substrate layer and a recording layer, which is capable of pressure-sensitive recording; a second layer having at least a second substrate layer; and a pseudo-adhesive layer via which the second layer is laminated on the recording layer side of the first layer, wherein the pseudo-adhesive layer is formed by a wet lamination method.

### BACKGROUND OF THE INVENTION

1. Field of the Invention

The present invention relates to a recording sheet having a recording layer, which is at least capable of pressure-sensitive recording.

Priority is claimed on Japanese Patent Application No. 2005-321993, filed Nov. 7, 2005, the content of which is incorporated herein by reference.

2. Description of the Related Art

Conventionally, since pressure-sensitive recording in which recording is carried out due to the applied pressure is a recording method where copying is also possible at the same time as recording, it has been adopted for receipts, documents for kept belongings or the like. In recent years, a recording sheet with a multilayered structure, where a layer which is capable of pressure-sensitive recording and another layer such as a heat-sensitive recording layer are superimposed, has also been proposed like the one described in Patent document 1, for example. In such a recording sheet with a multilayered structure, a method to partially adhere end parts only, and a method to form a sprocket hole in end parts of each layer and fitting the pins of a paper feed roller therein to hold so that each layer does not misalign or part are known.

[Patent document 1] Japanese Laid-Open Patent Application No. 2004-142141

However, it is difficult to form a roll with the recording sheet where only end parts are partially adhered or with the recording sheet where pins are fitted in sprocket holes to hold so that each layer does not misalign. For that reason, such recording sheets were, as shown in FIG. 6 of Patent document 1, made into a form of continuous slips. However, there was a problem of continuous slips being more difficult to handle compared to the one in a rolled form.

In order to solve such a problem, it is also conceivable to form an adhesive layer between layers of recording sheets by a dry lamination method or the like, pasting each layer together via this adhesive layer, integrating layers, and making into rolled forms. At this time, it is possible to make rolled forms by providing pseudo-adhesive layers, which have been put into practical use in recent years in the field of recording sheets and which adhere two layers that are subjects of adhesion in a manner capable of separating but incapable of repasting the two layers, as adhesive layers. Furthermore, it is considered that the provision of versatile recording sheets which can be peeled into two layers via the psudo-adhesive layers and which are also usable as receipts or the like for example, is possible.

However, with the dry lamination method, since the pseudo-adhesive agent is coated on a surface of one layer out of the two targeted layers and the other layer is superimposed thereon by pressure bonding after drying of the agent, high pressure is applied at the time of adhesion. Accordingly, when the recording sheet provided with a recording layer, which is capable of pressure-sensitive recording, is used, there is a problem of color development of the recording layer due to this pressure resulting in the occurrence of background staining in the obtained recording sheet. For this reason, it has been difficult to realize recording sheets which are provided with recording layers capable of pressure-sensitive recording and whose layers therebetween are adhered due to the pseudo-adhesive layers.

### SUMMARY OF THE INVENTION

The present invention is made by taking the above circumstances into consideration and it is an object to provide recording sheets, which are made by adhering a layer provided with a recording layer, which is capable of pressure-sensitive recording, with another layer provided with, for example, a heat-sensitive recording layer via a pseudo-adhesive layer and which have no background staining and which can also be made into rolled forms.

As a result of intensive research, the present inventors discovered that it is possible to solve the abovementioned problems by forming a pseudo-adhesive layer in order to bond the layer having a recording layer, which is capable of pressure-sensitive recording, with another layer by the wet lamination method to complete the present invention.

The recording sheet of the present invention is characterized by having a first layer which is provided with at least a first substrate layer and a recording layer, which is capable of pressure-sensitive recording, and a second layer which is provided with at least a second substrate layer wherein the second layer is laminated onto the recording layer side of the first layer and the pseudo-adhesive layer is formed by the wet lamination method.

The recording layer of the recording sheet may be a pressure-sensitive recording layer which contains a color former and developer and having a self-color developing property.

Moreover, the recording sheet may be a pressure-sensitive recording layer containing one of a color former and a developer and having a non-self-color developing property and at the same time, the second layer thereof further has a pressure-sensitive recording inducing layer containing the other of a color former and a developer, and the pressure-sensitive recording layer and the pressure-sensitive recording inducing layer are arranged so that they are adjacent to each other via the pseudo-adhesive layer.

The first layer and/or the second layer may have a heat-sensitive recording layer. Moreover, in the recording sheet, the recording layer thereof may be a pressure-sensitive/heat-sensitive recording layer which is capable of pressure-sensitive recording as well as heat-sensitive recording and in this case, the second layer may further have a heat-sensitive recording layer.

According to the present invention, it is possible to provide a recording sheet which is made by adhering the layer provided with a layer, which is capable of pressure-sensitive recording, and another layer provided with, for example, a heat-sensitive recording layer adhered via a pseudo-adhesive layer and which has no background staining and which is also possible to be made into rolled forms.

The recording sheet of the present invention has the first layer provided with at least a first substrate layer and a recording layer, which is capable of pressure-sensitive recording, and the second layer provided with at least a second substrate layer and the second layer is laminated onto the recording layer side of the first layer via the pseudo-adhesive layer. The pseudo-adhesive layer is formed by the wet lamination method.

The recording sheet of the present invention will be described below in detail using embodiments.

Note that in the present invention, the term “a recording layer which is capable of pressure-sensitive recording” indicates a layer which develops colors due to, at least, application of pressure and it may be a pressure-sensitive recording layer containing color formers and developers and having a self-color developing property (first to fifth embodiments). The recording layer may also be a pressure-sensitive recording layer containing one of a color former and a developer and which does not have a self-color developing property and which develops colors by pressure welding with another layer, which contains the other one of a color former and developer (referred to as a “pressure-sensitive recording inducing layer” in the present invention) (sixth embodiment). Furthermore, the recording layer may also be a pressure-sensitive/heat-sensitive recording layer which is capable of heat-sensitive recording in addition to pressure-sensitive recording (seventh embodiment).

### BRIEF DESCRIPTION OF THE DRAWINGS

FIG. 1 is a cross section of a recording sheet of the first embodiment

FIG. 2 is a cross section of a recording sheet of the second embodiment

FIG. 3 is a cross section of a recording sheet of the third embodiment.

FIG. 4 is a cross section of a recording sheet of the fourth embodiment.

FIG. 5 is a cross section of a recording sheet of the fifth embodiment.

FIG. 6 is a cross section of a recording sheet of the sixth embodiment.

FIG. 7 is a cross section of a recording sheet of the seventh embodiment.

### DETAILED DESCRIPTION OF THE INVENTION

### First Embodiment

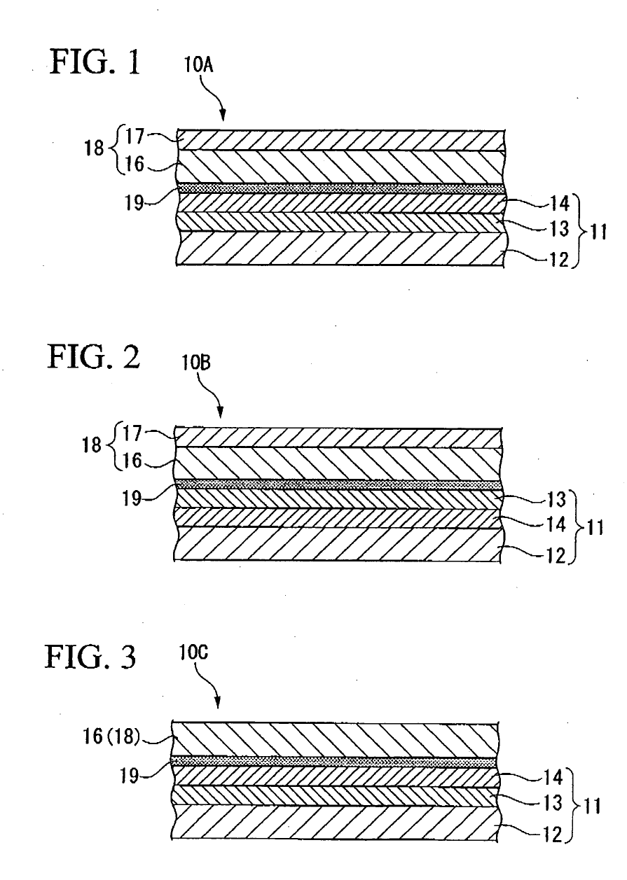

FIG. 1 shows a recording sheet 10A of a pressure-sensitive and heat-sensitive combined type/system. It is formed by laminating a first layer 11 in which a pressure-sensitive recording layer (a recording layer capable of pressure-sensitive recording) 13 having a self-color developing property and a heat-sensitive recording layer 14 are sequentially formed on one surface of a first substrate layer 12, and a second layer 18 in which a heat-sensitive recording layer 17 is formed on one surface of a second substrate layer 16, via a pseudo-adhesive layer 19, which is formed by a wet lamination method. In this embodiment, the heat-sensitive recording layer 14 of the first layer 11 and the second substrate layer 16 of the second layer 18 are arranged so that the two layers are adjacent to each other via the pseudo-adhesive layer 19. The recording sheet 10A of this embodiment records letters, images, or the like by pressure application or by heating from the outer surface side of the heat-sensitive recording layer 17 of the second layer 18.

(First Substrate Layer 12 and Second Substrate Layer 16)

Paper materials having pulp as a major component, film materials having various resins as major components, or the like can be used as the first substrate layer 12 and the second substrate layer 16, and they may be monolayered or multilayered formed from a plurality of layers. However, since the pseudo-adhesive layer 19 is formed by the wet lamination method, at least one of these substrate layers 12 and 16 preferably is air permeable. That is, although described in detail afterwards, when the pseudo-adhesive layer 19 is formed, one surface of one layer out of the first layer 11 and second layer 18 are coated with a coating liquid for the formation of the pseudo-adhesive layer 19 and the liquid is dried after the other layer is pasted together. For this reason, solvents in the coating liquid tend to transpire to the outside when the first substrate layer 12 and/or the second substrate layer 16 is air permeable.

Although the thickness of the first substrate layer 12 is not particularly limited, 40 to 100 μm is preferable from the viewpoint of suitability for adhesive processing, handleability, or the like.

Although the thickness of the second substrate layer 16 is not particularly limited either, the smaller the thickness of the second substrate layer 16, the larger the amount of heat transferred to the heat-sensitive recording layer 14 of the first layer 11 becomes. Accordingly, recording density of information recorded on the heat-sensitive recording layer 14 becomes higher and the recording becomes clear. On the other hand, the larger the thickness, the more workability of the second substrate layer 16 improves. From these viewpoints, the basis weight of the second substrate layer 16 is preferably between 3 and 60 g/m² and more preferably between 5 and 40 g/m². Moreover, the amount of heat transferred to the heat-sensitive recording layer 14 of the first layer increases as the density of the second substrate layer 16 increases and thus, recording density of information recorded on the heat-sensitive recording layer 14 becomes higher and the recording becomes clear. In addition, when the second substrate layer 16 is a paper base, transparency thereof increases as the density thereof increases. For this reason, for the second substrate layer 16, one with a density of 0.80 g/cm³ or more is preferable and a density within a range of 0.85 to 1.6 g/cm³ is more preferable. In particular, one with a density of 0.85 to 1.3 g/cm³ is preferable when the layer is a paper base and one with a density of 0.9 to 1.6 g/cm³ is preferable when the layer is a film substrate.

(Pressure-Sensitive Recording Layer 13)

The pressure-sensitive recording layer 13 of this embodiment is one containing microcapsules, which contain color formers, and developers and which has a so-called self-color developing property which develops colors when microcapsules are ruptured due to the applied pressure and the color formers and developers contact and react.

Such a pressure-sensitive recording layer 13 may be the one having a multilayer structure where a layer containing microcapsules, which contain color formers, but not developers (hereinafter, may be referred to as a color former layer) and a layer containing developers but not microcapsules, which contain color formers (hereinafter, may be referred to as a developer layer), are formed separately, or may be one having a monolayer structure formed from a layer containing both microcapsules, which contain color formers, and developers (hereinafter, may be referred to as a color former/developer layer).

An electron-releasing organic color former is usually used as a color former and an electron-accepting organic developer is usually used as a developer although inorganic developers may also be used.

Triarylmethane compounds, diarylmethane compounds, xanthene compounds, thiazine compounds, spiropyran compounds, lactam dyes, fluoran dyes, or the like can be used as the electron-releasing organic color former and those generally used for pressure-sensitive recording materials or heat-sensitive recording materials can be favorably used. These can be used singly or by combining two or more types.

Specific examples thereof include the compounds described in each of the publications such as Japanese Examined Patent Applications, Second Publication Nos. Sho 58-5940, Sho 49-17489, Sho 63-51113, Hei 4-5064, Hei 4-5065, Hei 4-5066, and Hei 4-5068; Japanese Unexamined Patent Applications, First Publication Nos. Sho 62-243652, Sho 62-243653, Sho 62-257970, Sho 62-288078, Sho 63-102975, Sho 63-37158, Sho 63-154389, Sho 63-185674, Sho 63-230387, Hei 4-173288, and Hei 5-32040, for example, triarylmethane compounds such as 3,3-bis(p-dimethylaminophenyl-6-dimethylaminophthalide (in other words, crystal violet lactone), 3,3-bis(p-dimethylaminophenyl)phthalide, 3-(p-dimethylaminophenyl)-3-(1,2-dimethylindol-3-yl)phthalide; diphenylmethane compounds such as 4,4-bis-dimethylaminobenzhydrylbenzylether, N-2,4,5-trichlorophenylleucoauramine; fluoran compounds such as 7-diethylamino-3-chlorofluoran, 7-diethylamino-3-chloro-2-methylfluoran, 2-phenylamino-3-methyl-6-(N-ethyl-N-p-tolylamino)fluoran; thiazine compounds such as benzoylleucomethylene blue and p-nitrobenzoylleucomethylene blue; and Spiro compounds such as 3-methyl-spiro-dinaphthopyran, 3-ethyl-spiro-dinaphthopyran, 3-propyl-spiro-dinaphthopyran, and 3-propyl-spiro-dibenzopyran.

Microcapsules containing color formers are usually in the form where droplets in which color formers are dissolved in oil (hereinafter may be referred to as a capsule oil) are encapsulated.

Aromatic synthetic oils such as diarylalkanes, alkylnaphthalenes, alkylated biphenyls, and 2-cyclohexylbiphenyl; aliphatic synthetic oils such as kerosene, naphtha, paraffin oil, and chlorinated paraffin; vegetable oils such as cottonseed oil, soybean oil, and linseed oil; or the like can be used as the capsule oil and those used for no-carbon pressure-sensitive recording materials generally can be favorably used. Among them, aromatic synthetic oils are particularly preferable for their dye solubility, stability, or the like. These can be used singly or by combining two or more types.

Although gelatin-type capsules produced by the coacervation method have prevailed in the past as microcapsules in the field of pressure-sensitive recording, microcapsules of synthetic resins produced by the interfacial polymerization method are now in the mainstream because of cheap and reliable supply of raw materials thereof, possible achievement of highly concentrated microcapsule emulsion, simple manufacturing process thereof, or the like. Specific examples of methods for producing such microcapsules include a method to produce polyurethane resins, polyurea resins, polyamide resins, or the like in the oil-water interface (for example, Japanese Examined Patent Applications, Second Publication Nos Sho 42-446, Sho 42-771, Sho 47-1763, and Sho 54-6506, Japanese Unexamined Patent Application, First Publication No. Sho 58-5503) and a method using aminoaldehyde resins such as urea-formaldehyde resin, melamine-formaldehyde resin, and melamine-urea-formaldehyde resin as capsule-wall films using in situ polymerization methods (Japanese Unexamined Patent Applications, First Publication Nos. sho 51-9079, sho 54-49984, sho 56-51238, and sho 56-102934). These microcapsules of synthetic resins are also preferably used in the present embodiment.

Polyelectrolytes are preferable as an emulsifier used for encapsulation by the in situ polymerization method. Specifically, aqueous solutions of a styrene-maleic anhydride copolymer, styrene-benzylmethacrylate-maleic anhydride copolymer, α-alkylstyrene-maleic anhydride copolymer, nuclear monoalkyl-substituted styrene-maleic anhydride copolymer, nuclear dialkyl-substituted styrene-maleic anhydride copolymer, styrene-maleic anhydride monoalkyl ester copolymer, ethylene-maleic anhydride monoalkyl ester copolymer, polystyrene sulfonate, polyacrylic acid, acrylic acid-acrylic ester copolymer or the like, or mixed solutions thereof are used.

As emulsifiers used for the interfacial polymerization method, in addition to those shown as examples in the in situ polymerization method, aqueous solutions of PVA, CMC, HEC, various starches (wheat, potato, corn, or the like) or mixed solutions thereof are also used. Note that it is also possible to add known substances which have nonionic, cationic, or zwitterionic surface activities to emulsifiers and to use the resultant concomitantly as long as microencapsulation is not affected.

The size (50% volume average diameter using a coulter counter) of microcapsules containing color formers is preferably in a range between 0.5 and 20 μm and particularly preferably in a range between 1 and 10 μm.

Electron-accepting organic and inorganic developers are not particularly limited. For example, those generally used in the fields of no-carbon pressure-sensitive, or heat-sensitive recording materials such as phenol polymers such as phenol-aldehyde polymers and phenol-acetylene polymers or polyvalent metal salts thereof, and aromatic carbonate compounds such as salicylic acid derivatives and salicylic acid resins or polyvalent metal salts thereof are used as organic developers. Although these can be used singly or by combining two or more types, aromatic carbonate compounds or polyvalent metal salts thereof are preferable among them due to their high printing densities and excellent fastness properties against light such as sunlight.

Examples of the salicylic acid derivatives include the compounds having at least one aromatic substituent such as 3-phenyl salicylate, 5-phenyl salicylate, 3-benzyl salicylate, 5-benzyl salicylate, 3-(α-methylbenzyl)salicylate, 5-(α-methylbenzyl)salicylate, 3-(α,α-dimethylbenzyl)salicylate, 5-(α,α-dimethylbenzyl)salicylate, 3,5-diphenyl salicylate, 3,5-di(α-methylbenzyl)salicylate, 3,5-dibenzyl salicylate, 3,5-di(α,α-dimethylbenzyl)salicylate, and 3,5-di(4-methylbenzyl)salicylate. These are preferably used as polyvalent metal salts. Examples of the salicylic acid resins include those obtained by reacting the abovementioned salicylic acid derivatives with styrene derivatives such as styrene, o-methylstyrene, m-methylstyrene, p-methylstyrene, α-methylstyrene, and β-methylstyrene by the Friedel-Crafts reaction with a mole ratio of 1:0.5 to 10 using a strong acid catalyst and those formed into polyvalent metal salts are preferably used. Moreover, preferable developers include the salicylic acids disclosed in Japanese Unexamined Patent Application, First Publication No. Hei 2-563 or polyvalent metal salts formed from those salicylic acids and multivalent metal compounds. Salicylic acid derivatives having an alkyl group and total carbon atoms of 8 or more, especially 8 to 20 are preferably used as salicylic acids.

These compounds can be used singly or by combining two or more types.

Polyvalent metal salts are, for example, produced by methods such as below. Salicylic acid derivatives are dissolved in solvents such as ethers, ketones, or acetic esters and multivalent metals and inorganic ammonium salts are added thereto. After heating the resulting solution for 1 to 6 hours at 40 to 100° C., the products are subjected to filtration and distillation to remove unreacted inorganic compounds and solvents. Specific examples of multivalent metals include magnesium, calcium, zinc, alminium, iron, cobalt, and nickel. Although these can be used singly or by combining two or more types, zinc is preferable.

Moreover, examples of inorganic developers include acid clay, attapulgite clay, and semisynthetic solid acids.

When the pressure-sensitive recording layer 13 has a multilayer structure with a color former layer and a developer layer, the color former layer contains a binder apart from microcapsules containing color formers and the developer layer contains a binder apart from developers made into particulate forms. In addition, pigments may be contained in the color former layer and developer layer where necessary.

Examples of binders include polyvinyl alcohols and derivatives thereof; starches and derivatives thereof; cellulose derivatives such as hydroxymethylcellulose, hydroxyethylcellulose, hydroxypropylcellulose, methylcellulose, and ethylcellulose; water-soluble polymer materials such as sodium polyacrylate, polyvinylpyrrolidone, acrylamide-acrylic ester copolymer, acrylamide-acrylic ester-methacrylic ester copolymers, styrene-maleic anhydride, isobutylene-maleic anhydride, casein, gelatin, and derivatives thereof; emulsions of polyvinyl acetate, polyurethane, polyacrylic acid, polyacrylic ester, vinyl chloride-vinyl acetate copolymer, polybutyl methacrylate, ethylene-vinyl acetate copolymer, or the like; and latexes of water-insoluble polymers such as styrene-butadiene copolymer and styrene-butadiene-acrylate copolymers.

As pigments, for example, inorganic pigments such as precipitated calcium carbonate light, calcium carbonate heavy, zinc oxide, magnesium oxide, titanium dioxide, kaolin, clay, calcined kaolin, delaminated kaolin, structured kaolin, magnesium sulfate, and calcium sulfate, and organic pigments (plastic pigments) such as polystyrene resin particles, urea formalin resin particles, microballoons, or the like are used. These binders and pigments can be used singly or by combining two or more types.

Moreover, the color former layer and the developer layer may contain, depending on the need, various additives such as water resistant additives, curing agents, crosslinking agents, antifoaming agents, coloring agents, wetting agents, flow modifying agents, preservatives, or surfactants, where appropriate.

When the pressure-sensitive recording layer 13 has a monolayer structure formed from a color former/developer layer, this layer contains microcapsules, which contain color formers, developers in particulate forms, binders, and pigments. As binders, pigments, and additives, those shown as examples previously can be used where appropriate.

(Heat-Sensitive Recording Layers 14 and 17)

The heat-sensitive recording layers 14 and 17 develop colors due to heating and may have multilayer structures where a layer containing reactive dyes but no developers (hereinafter referred to as a “reactive dye layer” in some cases) and a layer containing developers but no reactive dyes (hereinafter referred to as a “developer layer” in some cases) are formed separately. Additionally, the heat-sensitive recording layers 14 and 17 may have monolayer structures where a layer containing both reactive dyes and developers (hereinafter referred to as a “dye/developer layer” in some cases) is formed.

As reactive dyes and developers, various known materials can be used. Specific examples of combinations of reactive dyes and developers include leuco compounds (leuco dyes) and electron accepting substances, imino compounds and isocyanate compounds, and long chain fatty acid iron salts and polyhydric phenols. Among them, the combination of leuco compounds and electron accepting substances is preferable due to its good thermal responsiveness, high color optical density, and relative stability. Moreover, the combination of imino compounds and isocyanate compounds is preferable because the color development thereof is unlikely to be affected by surfactants and storage stability is excellent.

Examples of leuco compounds include, for example, compounds of triphenylmethanes, fluorans, phenothiazines, auramines, spiropyrans, indolinophthalides, or the like.

Specific examples include 3,3-bis(p-dimethylaminophenyl)phthalide, 3,3-bis(p-dimethylaminophenyl)-6-dimethylaminophthalide, 3,3-bis(p-dimethylaminophenyl)-6-diethylaminophthalide, 3,3-bis(p-dimethylaminophenyl)-6-chlorphthalide, 3,3-bis(p-dibutylaminophenyl)phthalide, 3-cyclohexylamino-6-chlorfluoran, 3-dimethylamino-5,7-dimethylfluoran, 3-N-methyl-N-isobutyl-6-methyl-7-anilinofluoran, 3-N-ethyl-N-isoamyl-6-methyl-7-anilinofluoran, 3-diethylamino-7-chlorofluoran, 3-diethylamino-7-methylfluoran, 3-diethylamino-7,8-benzfluoran, 3-diethylamino-6-methyl-7-chlorfluoran, 3-(N-ethyl-N-p-tolyl)-6-methyl-7-anilinofluoran, 3-(N-p-tolyl-N-ethylamino)-6-methyl-7-anilinofluoran, 3-pyrolidino-6-methyl-7-anilinofluoran, 2-[N-3′-trifluormethylphenyl]amino]-6-diethylaminofluoran, 2-[3,6-bis(diethylamino-9-(o-chloroanilino)xanthyl benzoic acid lactam], 3-diethylamino-6-methyl-7-(m-trichloromethylanilino)fluoran, 3-diethylamino-7-(o-chloranilino)fluoran, 3-dibutylamino-7-(o-chloranilino)fluoran, 3-N-methyl-N-amylamino-6-methyl-7-anilinofluoran, 3-N-methyl-N-cyclohexylamino-6-methyl-7-anilinofluoran, 3-diethylamino-6-methyl-7-anilinofluoran, 3-diethylamino-6-methyl-7-(2′,4′-dimethylanilino)fluoran, 3-(N,N-diethylamino)-5-methyl-7-(N,N-dibenzylamino)fluoran, benzoyl leuco methylene blue, 6′-chloro-8′-methoxy-benzoindolino-pyrylospiran, 6′-bromo-3′-methoxy-benzoindolino-pyrylospiran, 3-(2′-hydroxy-4′-dimethylaminophenyl)-3-(2′-methoxy-5′-chlorphenyl)phthalide, 3-(2′-hydroxy-4′-dimethylaminophenyl)-3-(2′-methoxy-5′-nitrophenyl)phthalide, 3-(2′-hydroxy-4′-diethylaminophenyl)-3-(2′-methoxy-5′-methylphenyl)phthalide, 3-(2′-methoxy-4′-dimethylaminophenyl)-3-(2′-hydroxy-4′-chlor-5′-methylphenyl)phthalide, 3-morpholino-7-(N-propyl-trifluoromethylanilino)fluoran, 3-pyrrolidino-7-trifluoromethylanilinofluoran, 3-diethylamino-5-chloro-7-(N-benzyl-trifluoromethylanilino)fluoran, 3-pyrrolidino-7-(di-p-chlorphenyl)methylaminofluoran, 3-diethylamino-5-chlor-7-(α-phenylethylamino)fluoran, 3-(N-ethyl-p-toluidino)-7-(α-phenylethylamino)fluoran, 3-diethylamino-7-(o-methoxycarbonylphenylamino)fluoran, 3-diethylamino-5-methyl-7-(α-phenylethylamino)fluoran, 3-diethylamino-7-piperidinofluoran, 2-chloro-3-(N-methyltoluidino)-7-(p-n-butylanilino)fluoran, 3-(N-methyl-N-isopropylamino)-6-methyl-7-anilinofluoran, 3-dibutylamino-6-methyl-7-anilinofluoran, 3,6-bis(dimethylamino)fluorenespiro(9,3′)-6′-dimethylaminophthalide, 3-(N-benzyl-N-cyclohexy)amino)-5,6-benzo-7-α-naphthylamino-4′-bromofluoran, 3-diethylamino-6-chlor-7-anilinofluoran, 3-N-ethyl-N-(2-ethoxypropyl)amino-6-methyl-7-anilinofluoran, 3-N-ethyl-N-tetrahydro furfurylamino-6-methyl-7-anilinofluoran, 3-diethylamino-6-methyl-7-methylidino-4′,5′-benzofluoran.

These leuco compounds can be used singly or by combining two or more types.

Electron accepting substances which contact the leuco compounds and make them develop colors are not particularly limited and examples thereof include phenol compounds, thiophenol compounds, thiourea derivatives, organic acids and metal salts thereof.

Specific examples include phenol compounds such as 4-tert-butylphenol, 4-acetylphenol, 4-tert-octylphenol, 4,4′-sec-butylidenediphenol, 4-phenylphenol, 4,4′-dihydroxydiphenylmethane, 4,4′-isopropylidenediphenol, 4,4′-cyclohexylidenediphenol, 1,1-bis(4-hydroxyphenyl)-1-phenylethane, 4,4′-dihydroxydiphenylsulfide, 4,4′-thiobis(3-methyl-6-tert-butylphenol), 4,4′-dihydroxydiphenylsulfone, 2,4′-dihydroxydiphenylsulfone, 4-hydroxy-4′-isopropoxydiphenylsulfone, bis(3-allyl-4-hydroxyphenyl)sulfone, bis(p-hydroxyphenyl)butylacetate, and bis(p-hydroxyphenyl)methylacetate; phenol compounds such as 4-hydroxybenzophenone, 4-hydroxydimethylphthalate, 4-hydroxymethylbenzoate, 4-hydroxypropylbenzoate, 4-hydroxy-sec-butylbenzoate, 4-hydroxyphenylbenzoate, 4-hydroxybenzylbenzoate, 4-hydroxytolylbenzoate, 4-hydroxychlorophenylbenzoate, 4,4′-dihydroxydiphenylether; or aromatic carboxylic acids such as benzoic acid, p-tert-butylbenzoate, trichlorobenzoate, terephthalic acid, salicylic acid, 3-tert-butylsalicylic acid, 3-isopropylsalicylic acid, 3-benzylsalicylic acid, 3-(α-methylbenzyl)salicylic acid, and 3,5-di-tert-butylsalicylic acid; and organic acid substances such as the salts between these phenol compounds or aromatic carboxylic acids and multivalent metals such as zinc, magnesium, aluminium, or calcium; and urea compounds such as N-p-toluenesulfonyl-N′-3-(p-toluenesulfonyloxy)phenylurea, N-(p-toluenesulfonyl)-N′-(p-butoxycarbonyl)urea, and N-p-tolylsulfonyl-N′-phenylurea. These electron accepting substances can be used singly or by combining two or more types.

Imino compounds are compounds having at least one imino group (═NH) and examples thereof include, for example, colorless or hypochromic compounds which are in solid forms at normal temperature and represented by the general formula below. 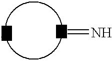
In the formula, X represents an aromatic compound residue which optionally forms a conjugated system with the adjacent C═N.

Specific examples of imino compounds include 3-iminoisoindolin-1-one, 3-imino-4,5,6,7-tetrachloroisoindolin-1-one, 3-imino-4,5,6,7-tetrabromoisoindolin-1-one, 3-imino-4,5,6,7-tetrafluoroisoindolin-1-one, 3-imino-5,6-dichloroisoindolin-1-one, 3-imino-4,5,7-trichloro-6-methoxy-isoindolin-1-one, 3-imino-4,5,7-trichloro-6-methylmercapto-isoindolin-1-one, 3-imino-6-nitroisoindolin-1-one, 3-imino-isoindoline-1-spiro-dioxoran, 1,1-dimethoxy-3-imino-isoindoline, 1,1-diethoxy-3-imino-4,5,6,7-tetrachloroisoindoline, 1-ethoxy-3-imino-isoindoline, 1,3-diiminoisoindoline, 1,3-diimino-4,5,6,7-tetrachloroisoindoline, 1,3-diimino6-methoxyisoindoline, 1,3-diimino-6-cyanoisoindoline, 1,3-diimino-4,7-dithia-5,5,6,6-tetrahydroisoindoline, 7-amino-2,3-dimethyl-5-oxopyrrolo[3,4b]pyrazine, 7-amino-2,3-diphenyl-5-oxopyrrolo[3,4b]pyrazine, 1-iminonaphthalic acid imide, 1-iminodiphenic acid imide, 1-phenylimino-3-iminoisoindoilne, 1-(3′-chlorophenylimino)-3-iminoisoindoline, 1-(2′,5′-dichlorophenylimino)-3-iminoisoindoline, 1-(2′,4′,5′-trichlorophenylimino)-3-iminoisoindoline, 1-(2′-cyano-4′-nitrophenylimino)-3-iminoisoindoline, 1-(2′-chloro-5′-cyanophenylimino)-3-iminoisoindoline, 1-(2′,6′-dichloro-4′-nitrophenylimino)-3-iminoisoindoline, 1-(2′,5′-dimethoxyphenylimino)-3-iminoisoindoline, 1-(2′,5′-diethoxyphenylimino)-3-iminoisoindoline, 1-(2′-methyl-4′-nitrophenylimino)-3-iminoisoindoline, 1-(5′-chloro-2′-phenoxyphenylimino)-3-iminoisoindoline, 1-(4′-N,N-dimethylaminophenylimino)-3-iminoisoindoline, 1-(3′-N,N-dimethylamino-4′-methoxyphenylimino)-3-iminoisoindoline, 1-(2′-methoxy-5′-N-phenylcarbamoylphenylimino)-3-iminoisolindoline, 1-(2′-chloro-5′-trifluoromethylphenylimino)-3-iminoisoindoline, 1-(5′,6′-dichlorobenzothiazolyl-2′-imino)-3-iminoisoindoline, 1-(6′-methylbenzothiazolyl-2′-imino)-3-iminoisoindoline, 1-(4′-phenylaminophenylimino)-3-iminoisoindoline, 1-(p-phenylazophenylimino)-3-iminoisoindoline, 1-(naphthyl-1′-imino)-3-iminoisoindoline, 1-(anthraquinone-1′-imino)-3-iminoisoindoline, 1-(5′-chloroanthraquinone-1′-imino)-3-iminoisoindoline, 1-(N-ethylcarbazolyl-3′-imino)-3-iminoisoindoline, 1-(naphthoquinone-1′-imino)-3-iminoisoindoline, 1-(pyridyl-4′-imino)-3-iminoisoindoline, 1-(benzimidazolone-6′-imino)-3-iminoisoindoline, 1-(1′-methylbenzimidazolone-6′-imino)-3-iminoisoindoline, 1-(7′-chlorobenzimidazolone-5′-imino)-3-iminoisoindoline, 1-(benzimidazolyl-2′-imino)-3-iminoisoindoline, 1-(benzimidazolyl-2′-imino)-3-imino-4,5,6,7-tetrachloroisoindoline, 1-(2′,4′-dinitrophenylhydrazon)-3-iminoisoindoline, 1-(indazolyl-3′-imino)-3-iminoisoindoline, 1-(indazolyl-3′-imino)-3-imino-4,5,6,7-tetrabromoisoindoline, 1-(indazolyl-3′-imino)-3-imino-4,5,6,7-tetrafluoroisoindoline, 1-(benzimidazolyl-2′-imino)-3-imino-4,7-dithiatetrahydroisoindoline, 1-(4′,5′-dicyanoimidazolyl-2′-imino)-3-imino-5,6-dimethyl-4,7-pyraziisoindoline, 1-(cyanobenzoylmethylene)-3-iminoisoindoline, 1-(cyanocarbonamidemethylene)-3-iminoisoindoline, 1-(cyanocarbomethoxymethylene)-3-iminoisoindoline, 1-(cyanocarboethoxymethylene)-3-iminoisoindoline, 1-(cyano-N-phenylcarbamoylmethylene)-3-iminoisoindoline, 1-[cyano-N-(3′-methylphenyl)carbamoylmethylene]-3-iminoisoindoline, 1-[cyano-N-(4′-chlorophenyl)-carbamoylmethylene]-3-iminoisoindoline, 1-[cyano-N-(4′-methoxyphenyl)-carbamoylmethylene]-3-iminoisoindoline, 1-[cyano-N-(3′-chloro-4′-methylphenyl)-carbamoylmethylene]-3-iminoisoindoline, 1-(cyano-p-nitrophenylmethylene)-3-iminoisolindoline, 1-(dicyanomethylene)-3-iminoisoindoline, 1-[cyano-1′,2′,4′-triazolyl-(3′)-carbamoylmethylene]-3-iminoisolindoline, 1-[cyanothiazoyl-(2′)-carbamoylmethylene)-3-iminoisoindoline, 1-[cyanobenzimidazolyl-(2′)-carbamoylmethylene]-3-iminoisoindoline, 1-[cyanobenzothiazolyl-(2′)-carbamoylmethylene]-3-iminoisoindoline, 1-[cyanobenzimidazolyl-(2′)-methylene]-3-iminoisoindoline, 1-[cyanobenzimidazolyl-(2′)-methylene]-3-imino-4,5,6,7-tetrachloroisoindoline, 1-[(cyanobenzimidazolyl-2′)-methylene]-3-imino-5-methoxyisoindoline, 1-[(cyanobenzimidazolyl-2′)-methylene]-3-imino-6-chloroisoindoline, 1-[(1′-phenyl-3′-methyl-5-oxo)-pyrazolidene-4′]-3-iminoisoindoline, 1-[(cyanobenzimidazolyl-2′)-methylene]-3-imino-4,7-dithiatetrahydroisoindoline, 1-[(cyanobenzimidazolyl-2′)-methylene]-3-imino-5,6-dimethyl-4,7-pyraziisoindoline, 1-[(1′-methyl-3′-n-butyl)barbituric acid-5′]-3-iminoisoindoline, 3-imino-1-sulfobenzoic acid imide, 3-imino-1-sulfo-6-chlorobenzoic acid imide, 3-imino-1-sulfo-5,6-dichlorobenzoic acid imide, 3-imino-1-sulfo-4,5,6,7-tetrachlorobenzoic acid imide, 3-imino-1-sulfo-4,5,6,7-tetrabromobenzoic acid imide, 3-imino-1-sulfo-4,5,6,7-tetrafluorobenzoic acid imide, 3-imino-1-sulfo-6-nitrobenzoic acid imide, 3-imino-1-sulfo-6-methoxybenzoic acid imide, 3-imino-1-sulfo-4,5,7-trichloro-6-methylmercaptobenzoic acid imide, 3-imino-1-sulfonaphthoic acid imide, 3-imino-1-sulfo-5-bromonaphthoic acid imide, and 3-imino-2-methyl-4,5,6,7-tetrachloroisoindolin-1-one.

Examples of isocynate compounds which make contact with imino compounds and make them develop colors include aromatic or heterocyclic isocyanate compounds that are colorless or hypochromic and that are in solid forms at normal temperature. Specific examples thereof include 2,6-dichlorophenylisocyanate, p-chlorophenylisocyanate, 1,3-phenylenediisocyanate, 1,4-phenylenediisocyanate, 1,3-dimethylbenzene-4,6-diisocyanate, 1,4-dimethylbenzene-2,5-diisocyanate, 1-methoxybenzene-2,4-diisocyanate, 1-methoxybenzene-2,5-diisocyanate, 1-ethoxybenzene-2,4-diisocyanate, 2,5-dimethoxybenzene-1,4-diisocyanate, 2,5-diethoxybenzene-1,4-diisocyanate, 2,5-dibutoxybenzene-1,4-diisocyanate, azobenzene-4,4′-diisocyanate, diphenylether-4,4′-diisocyanate, naphthalene-1,4-diisocyanate, naphthalene-1,5-diisocyanate, naphthalene-2,6-diisocyanate, naphthalene-2,7-diisocyanate, 3,3′-dimethyl-biphenyl-4,4′-diisocyanate, 3,3′-dimethoxybiphenyl-4,4′-diisocyanate, diphenylmethane-4,4′-diisocyanate, diphenyldimethylmethane-4,4′-diisocyanate, benzophenone-3,3′-diisocyanate, fluorene-2,7-diisocyanate, anthraquinone-2,6-diisocyanate, 9-ethylcarbazol-3,6-diisocyanate, bilene-3,8-diisocyanate, naphthalene-1,3,7-triisocyanate, biphenyl-2,4,4′-triisocyanate, 4,4′,4″-triisocyanato-2,5-dimethoxytriphenylamine, 4,4′,4″-triisocyanatotriphenylamine, p-dimethylaminophenylisocyanate, and tris(4-phenylisocyanate)thiophosphate. These isocyanate compounds may be used, if needed, in the form of so-called block isocyanates, which are addition compounds with phenols, lactams, and oximes; in the form of dimers of diisocyanates, for example, a dimer of 1-methylbenzene-2,4-diisocyanate; and in the form of isocyanurate, which is a trimer; and moreover, they can be used as polyisocyanates, which are adducted by various polyols or the like.

When taking color developing properties into consideration, the content of reactive dyes in the heat-sensitive recording layers 14 and 17 is preferably in a range between 10 and 50 mass % and more preferably between 10 and 20 mass %. Additionally, the content of developers in the heat-sensitive recording layers 14 and 17 is preferably in a range between 100 and 700 mass parts and more preferably between 150 and 400 mass parts relative to 100 mass parts of reactive dyes.

The heat-sensitive recording layers 14 and 17 contain binders in addition to the reactive dyes and developers. Binders can be appropriately selected from those shown in the examples of the pressure-sensitive recording layer 13. The content of the binders in the heat-sensitive recording layers 14 and 17 is preferably between 5 and 40 mass % and more preferably between 10 and 30 mass %.

The heat-sensitive recording layers 14 and 17 preferably further contain sensitizers in order to adjust color developing sensitivity. As sensitizers, compounds conventionally known as sensitizers of the heat-sensitive recording bodies can be used and examples thereof include organic matter with relatively low melting points and having good compatibility with reactive dyes and developers (hereinafter referred to as ♭heat-fusible substances”). By becoming compatible with reactive dyes and developers, the heat-fusible substances enhance contact probability between these two components and thereby exert a sensitizing effect.

Examples of the heat-fusible substances include para-benzylbiphenyl, dibenzylterephthalate, 1-hydroxy-2-naphthoate phenyl, dibenzyl oxalate, di-o-chlorbenzyl adipate, 1,2-di(3-methylphenoxy)ethane, di-p-methylbenzyl oxalate, di-p-chlorbenzyl oxalate, 1,2-bis(3,4-dimethylphenyl)ethane, 1,3-bis(2-naphthoxy)propane.

The content of the heat-fusible substances in the heat-sensitive recording layers 14 and 17 is preferably between 25 and 500 mass parts and more preferably between 100 and 300 mass parts relative to 100 mass parts of reactive dyes.

The heat-sensitive recording layers 14 and 17 may further contain image stabilizers in order to achieve a main object of improving in preservability of characters, images, or the like which are thermally recorded.

As image stabilizers, for example, one or more compounds selected from phenol compounds such as 1,1,3-tris(2-methyl-4-hydroxy-5-cyclohexylphenyl)butane, 1,1,3-tris(2-methyl-4-hydroxy-5-tert-butylphenyl)butane, 1,1-bis(2-methyl-4-hydroxy-5-tert-butylphenyl)butane, 4,4′-[1,4-phenylenebis(1-methylethylidene)]bisphenol, and 4,4′-[1,3-phenylenebis(1-methylethylidene)]bisphenol; epoxy compounds such as 4-benzyloxyphenyl-4′-(2-methyl-2,3-epoxypropyloxy)phenylsulfone, 4-(2-methyl-1,2-epoxyethyl)diphenylsulfone, and 4-(2-ethyl-1,2-epoxyethyl)diphenylsulfone; and isocyanurate compounds such as 1,3,5-tris(2,6-dimethylbenzyl-3-hydroxy-4-tert-butyl)isocyanurate can be used. The content of the image stabilizers in the heat-sensitive recording layers 14 and 17 is preferably between 5 and 100 mass parts and more preferably between 10 and 60 mass parts relative to 100 mass parts of reactive dyes.

The heat-sensitive recording layers 14 and 17 may further contain crosslinking agents which are for subjecting the abovementioned binders to three-dimensional curing in order to improve water resistance.

Examples of crosslinking agents include aldehyde compounds such as glyoxal; polyamine compounds such as polyethyleneimine; epoxy compounds; polyamide resins; melamine resins; dimethylolurea compounds; aziridine compounds; block isocyanate compounds; and inorganic compounds such as ammonium persulfate, ferric chloride, magnesium chloride, sodium tetraborate, and potassium tetraborate; or boric acid, borate triesters, boron polymers or the like.

The loadings of the crosslinking agents in the heat-sensitive recording layer 14 and 17 are preferably within a range between 1 and 10 mass %.

The heat-sensitive recording layers 14 and 17 can also contain pigments.

Examples of pigments include inorganic pigments such as calcium carbonate, magnesium carbonate, kaolin, clay, talc, calcined clay, silica, diatomaceous earth, synthetic aluminium silicate, zinc oxide, titanium oxide, alminium hydroxide, barium sulfate, and calcium carbonate or silica, which is subjected to surface treatment; and organic pigments such as urea-formalin resin, styrene-methacrylic acid copolymer resin, and polystyrene resin.

The content of pigments in the heat-sensitive recording layers 14 and 17 is preferably an amount which does not reduce color optical density and is preferably 50 mass % or less.

Moreover, the pigment content is preferably 1 to 100 mass parts and more preferably 5 to 50 mass parts relative to 100 mass parts of reactive dyes.

It is possible to further add, where necessary, various additives which are generally used in heat-sensitive recording bodies to the heat-sensitive recording layers 14 and 17. Examples of such additives include waxes, metal soaps, colored dyes, fluorescent dyes, oil repelling agents, antifoaming agents, and viscosity controlling agents.

Examples of waxes include polyolefin waxes such as paraffin wax, carnauba wax, microcrystalline wax, and polyethylene wax; higher fatty acid amides such as stearic acid amide and ethylene bis-stearic acid amide; and higher fatty acid esters and derivatives thereof. In particular, sensitizing effects can be achieved without impairing the anti-fogging property of the background when methylolated fatty acid amide is added to the heat-sensitive recording layers 14 and 17.

Examples of metal soaps include polyvalent metal salts of higher fatty acids such as zinc stearate, aluminium stearate, calcium stearate, and zinc oleate.

(Pseudo-Adhesive Layer 19)

The pseudo-adhesive layer 19 in the present embodiment is one in which the first layer 11 and the second layer 18 are adhered so that the two layers are separable from each other but, at the same time, cannot be pasted again and which is formed by the wet lamination method.

The pseudo-adhesive layer 19 is used for pseudo-adhesion as an adhesive component and preferably contains various pseudo-adhesive agents where the wet lamination method is applicable and further contains adhesive-force adjusting agents.

As such pseudo-adhesive agents, adhesives based on rubbers such as natural rubber and synthetic rubber; acrylic adhesives which contain acrylic acid and/or acrylic esters as a major monomer component; vinyl acetate adhesives which contain vinyl acetates such as vinyl acetate polymers, and ethylene-vinyl acetate copolymers (EVA) as major monomer components; water-soluble adhesives such as polysaccharide adhesives including starches and sodium alginate and dextrin adhesives, or the like can be used.

Adhesives of rubbers, acrylates, vinyl acetates, and dextrins are preferable among them as their adhesive properties can be widely controlled arbitrarily. Although adhesives are appropriately selected by taking adhesive strengths or the like into consideration, since this pseudo-adhesive layer 19 is formed by the wet lamination method, adhesives of vinyl acetates and/or dextrins are more preferable.

The content of pseudo-adhesive agents in the pseudo-adhesive layer 19 is preferably 10 to 100 mass % and more preferably 20 to 80 mass %.

Examples of adhesive-force adjusting agents include waxes such as polyethylene waxes, metal soaps, and inorganic and organic pigments which are shown as examples of additives contained in the heat-sensitive recording layers 14 and 17. These adhesive-force adjusting agents disperse in the pseudo-adhesive layer 19 and have an effect of reducing the cohesive force of the pseudo-adhesive layer 19. The first layer 11 and the second layer 18 become readily separable due to the reduction of the cohesive force of the pseudo-adhesive layer 19.

The content of the adhesive-force adjusting agent in the pseudo-adhesive layer 19 is appropriately determined by taking the adhesive strength between the first layer 11 and the second layer 18, cohesive force of the pseudo-adhesive layer 19, or the like into consideration. In particular, it is preferable to dispense the amount so that the adhesive strength between the first layer 11 and the second layer 18 is within the range, which will be described layer, and, for example, in the pseudo-adhesive layer 19, 0 to 90 mass % is preferable and 20 to 80 mass % is more preferable.

The adhesive strength between the first layer 11 and the second layer 18 in the pseudo-adhesive layer 19 is preferably 50 to 1000 mN/25 mm (peel rate 300 mm/min) and more preferably 80 to 600 mN/25 mm (peel rate 300 mm/min) when conforming to the T-peel test, which is stipulated in JIS K 6854-3.

When the adhesive strength measured by the T-peel test is lower than 50 mN/25 mm, there is a possibility of the first layer 11 and the second layer 18 separating readily or the appearance deteriorating due to the occurrence of curls and wrinkles. Additionally, when the adhesive strength measured by the T-peel test exceeds 1000 mN/25 mm, there is a possibility of breaking the first layer 11 and/or the second layer 18 when separating the two, or of the layers being strongly curled in the flow direction and likely to becoming tubular.

The adhesive strength measured by the T-peel test can be appropriately adjusted depending on the types of pseudo-adhesive agents used and permeability due to the agents, coating amount, time between the coating and pasting processes, drying temperature, or the like.

The adhesive strength by the T-peel test stipulated in JIS K 6854-3 can be measured by the procedure below. That is, after leaving the sample under an environment where the temperature is 23° C. and relative humidity is 50% for 24 hours or more, the peeling test is carried out with a peel rate of 300 mm/min. Adhesive strength is indicated by the unit of mN required for peeling 25 mm of the test sample.

(Production Method of the Recording Sheet 10A)

Although the production method of the recording sheet 10A shown in FIG. 1 is not limited as long as it is a method to adhere the first layer 11 and the second layer 18 via the pseudo-adhesive layer 19 by the wet lamination method, the method to form the heat-sensitive recording layer 17 on the second substrate layer 16 after adhering the first layer 11 and the second layer 16 via the pseudo-adhesive layer 19 by the wet lamination method is preferable. According to this method, wrinkles or the like are unlikely to occur on the second substrate layer 16 and the recording sheet 10A with an excellent appearance can be obtained. For example, when the second substrate layer 16 is formed of a paper base, stretches, wrinkles, paper cutting or the like may occur thereon by water absorption at the time of forming the pseudo-adhesive layer 19. Even when the second substrate layer 16 is formed of a film substrate, when the thickness thereof is thin, there is a possibility of the occurrence of deformations such as wrinkles due to weakened stiffness thereof or more handling difficulties. On the other hand, these problems can be improved by forming the heat-sensitive recording layer 17 on the second substrate layer 16 after adhering the first layer 11 and the second substrate layer 16 via the pseudo-adhesive layer 19.

As a specific production method, firstly, a coating liquid for forming the pressure-sensitive recording layer 13 (hereinafter may also be referred to as the coating liquid for the formation of the pressure-sensitive recording layer) is prepared, coated on one surface of the first substrate layer 12, and dried.

When the pressure-sensitive recording layer 13 has a multilayered structure where the color former layer and developer layer are formed separately, each of the coating liquid for forming the color former layer and the coating liquid for forming the developer layer is prepared as the coating liquid for the formation of pressure-sensitive recording layer and any one of the two is coated on one surface of the first substrate layer 12 and after drying, the other is coated thereon and dried. The coating liquid for forming the color former layer is obtained by dispersing microcapsules, which contain color formers, binders, and pigments or additives used where needed in a dispersion medium such as water. The coating liquid for forming the developer layer is obtained by dispersing developers in particulate forms, binders, and pigments or additives used where needed in a dispersion medium such as water.

In this case, either of the color former layer and developer layer may be formed so as to contact the first substrate layer 12. However, since the recording sheet 10A of this embodiment carries out recording by pressure applied from the outer surface side of the heat-sensitive recording layer 17 of the second layer 18, it is more preferable to form the developer layer to contact the first substrate layer 12 and to form the color former layer, which has microcapsules containing color formers, thereon since microcapsules possibly become more likely to be ruptured due to the applied pressure.

In addition, it is preferable to coat 2.0 to 7.0 g/m² of the coating liquid for forming the color former layer by dry mass and 3.0 to 6.0 g/m² is more preferable. It is preferable to coat 3.0 to 10.0 g/m² of the coating liquid for forming the developer layer by dry mass and 4.0 to 7.0 g/m² is more preferable.

On the other hand, when the pressure-sensitive recording layer 13 has a monolayer structure formed from a color former/developer layer, the coating liquid for the formation of the pressure-sensitive recording layer where color formers, developers, binders, and pigments or additives used where needed are dispersed in a dispersion medium such as water is prepared, coated on one surface of the first substrate layer 12, and dried. In this case, it is preferable to coat 5.0 to 15.0 g/m² by dry mass and 7.0 to 10.0 g/m² is more preferable.

For preparing each coating liquid, agitators/grinders, for example, ball mills, atriters, and sand mills can be used.

An air knife coater, blade coater, short dwell coater, rod blade coater, roll coater, bar coater, size press coater, bill blade coater, or the like can be used for the coating of each coating liquid. Since excessive pressure is not applied onto the target material to be coated when an air knife coater, curtain coater, dye coater, or the like is used, when a color former layer, which contains microcapsules, is already formed on the first substrate layer 12 and when forming a developer layer thereon, it is preferable to select these coaters among the coaters listed above in order to prevent the rupture of microcapsules.

After forming the pressure-sensitive recording layer 13 onto the first substrate layer 12 as described above, a coating liquid (hereinafter may also be referred to as the “coating liquid for the formation of heat-sensitive recording layer”) is coated onto this pressure-sensitive recording layer 13, and then dried to form the heat-sensitive recording layer 14.

Although the heat-sensitive recording layer 14 may have a multilayered structure where the reactive dye layer and the developer layer are formed separately as described above, it is more preferable that the heat-sensitive recording layer 14 should have a monolayer structure formed from a dye/developer layer containing both reactive dyes and developers because of the excellent reactivity and thermal responsiveness thereof.

In this case, reactive dyes, developers, binders, and pigments and additives used where necessary, are dispersed in a dispersion medium such as water to prepare the coating liquid for the formation of the heat-sensitive recording layer and the prepared liquid is coated onto the pressure-sensitive recording layer, which is already formed, and then dried. Moreover, in this case, it is preferable to prepare two dispersion liquids by dispersing reactive dyes and developers in a separate dispersion medium and mixing the two dispersion liquids at the time of forming the heat-sensitive recording layer 14.

The coating amount of the coating liquid for the formation of heat-sensitive recording layer is preferably 1 to 10 g/m² and more preferably 2 to 5 g/m² by dry mass when considering a color developing property thereof.

In addition, various agitators/grinders or various coaters shown as examples in the formation of the pressure-sensitive recording layer 13 can be used for preparing and coating the coating liquid for the formation of the heat-sensitive recording layer.

By forming the heat-sensitive recording layer 14 as described above, the first layer 11 where the first substrate layer 12, the pressure-sensitive recording layer 13, and the heat-sensitive recording layer 14 are sequentially formed is obtained.

It should be noted that the outer surface of the heat-sensitive recording layer 14 may be subjected to a smoothing treatment using known smoothing methods such as super calendar and soft calendar. Color developing sensitivity thereof can be enhanced due to this treatment. In the smoothing treatment, the outer surface of the heat-sensitive recording layer 14 may be treated by being made to contact either of a metal roll or elastic roll.

Subsequently, the coating liquid for forming the pseudo-adhesive layer 19 (hereinafter may also be referred to as the “coating liquid for the formation of pseudo-adhesive layer”) is prepared. This prepared liquid is coated on the surface of the heat-sensitive recording layer 14 of the first layer 11 or of the second substrate layer 16 and by the wet lamination method where the first layer 11 and the second substrate layer 16 are pasted together without drying the coating liquid and thereafter drying the coating liquid, an intermediate of the recording sheet where the first layer 11 and the second substrate layer 16 are adhered via the pseudo-adhesive layer 19 is produced.

An aqueous emulsion formed of pseudo-adhesive agents such as vinyl acetates or an aqueous solution formed by dissolving water-soluble pseudo-adhesive agents such as dextrins in water can be preferably used as the coating solution for the formation of the pseudo-adhesive layer and adhesive-force adjusting agents are blended where necessary. The coating method of this coating liquid can be carried out similarly to the case of the pressure-sensitive recording layer 13 in the first layer 11.

The coating amount of the coating liquid for the formation of pseudo-adhesive layer is preferably 0.5 to 10 g/m² and more preferably 1 to 5 g/m² because of excellent recording characteristics thereof.

According to such a wet lamination method, since the first layer 11 and the second layer 18 are pasted together before the coating liquid is dried, hardly any pressure is required at the time of pasting and pseudo-adhesion is sufficiently achieved even with a line pressure of 980 N/m (1 kg/cm) or less. Accordingly, as shown in this embodiment, even when the first layer 11 has the pressure-sensitive recording layer 13, which develops colors when pressure is applied, the pressure-sensitive recording layer 13 does not develop colors by the applied pressure at the time of pasting and background staining does not occur. Furthermore, according to the wet lamination method, there is also the merit of the pressure carried to the pressure-sensitive recording layer 13 at the time of pasting becoming more alleviated since the moisture in the coating liquid acts as a buffer material. If the dry lamination method where the adhesive agent is coated on the first layer and the second substrate layer is pressure-bonded thereto after drying the agent is adopted at this stage, there is a need to pressure-bond with a line pressure of approximately 19600 N/m (20 kg/cm) and this method causes background staining on the pressure-sensitive recording layer due to the pressure applied at the time of pasting. Moreover, even when the extrusion lamination method where molten resin of high temperature is extruded between the first and second layers to paste them together is adopted, there is a major problem of the color development in the heat-sensitive recording layer due to the heat of molten resin in cases where the first layer has a heat-sensitive recording layer like the present embodiment or the second and third embodiments described later.

In addition, according to the wet lamination method, since the coating amount of the coating liquid for the formation of the pseudo-adhesive layer is also smaller than that needed for the dry lamination method, the time required for drying is also shorter. Accordingly, it enables mass production at high speed and is excellent in terms of productivity and manufacturing cost. Moreover, when the coating amount of the coating liquid for the formation of pseudo-adhesive layer is small, it is possible to use the second substrate layer 16 with a thickness of 5 μm or less and the pseudo-adhesive layer 19 itself can also be made thin. For that reason, favorable heat transfer and from the first layer 11 to the heat-sensitive recording layer 14 and pressure transmission to the pressure-sensitive recording layer 13, is achieved and clear recording can be performed. Furthermore, the total thickness of the recording sheet 10A can be made thin and it becomes more appropriate for handling thereof as a roll. If, at this stage, the pseudo-adhesive layer is formed by the extrusion lamination method, since the formed layer would have a thickness of some event, there is a problem of heat transfer or pressure transmission to the heat-sensitive or pressure-sensitive recording layer, which is arranged in the lower layer side than the formed layer, becoming poor.

Next, the coating liquid for the formation of heat-sensitive recording layer is coated on the second substrate layer 16 of the obtained recording sheet intermediate, dried, and thereby forming the heat-sensitive recording layer 17 to obtain the recording sheet 10A shown in FIG. 1.

The formation of the heat-sensitive recording layer 17 in this case can be carried out in a similar way to that used for the formation of heat-sensitive recording layer 14 of the first layer 11.

Recording of letters and images can be carried out with the recording sheet 10A obtained as described above by applying pressure or by heating from the outer surface side of the heat-sensitive recording layer 17 of the second layer 18. Accordingly, the sheet can be used effectively for contract documents or the like.

For example, one person thermally prints the sentence describing the contractual coverage with a thermal printer on one part of the outer surface of the heat-sensitive recording layer 17 of the second layer 18 in advance. In this case, the same sentence is recorded also on the heat-sensitive recording layer 14 of the first layer 11.

Then when he and another person come to an agreement on the contractual coverage recorded on the recording sheet 10A, they both write their signatures on the part in the outer surface of the heat-sensitive recording layer 17 of the second layer 18 other than the aforementioned part. In this case, since pressure is also applied at the same time together with the signing, both signatures are also recorded on the pressure-sensitive recording layer 13 of the first layer 11.

By separating the first layer 11 and second layer 18 into two by delamination due to the cohesive failure in the pseudo-adhesive layer 19, one becomes a contract document for one person to keep and another becomes a contract document for another person to keep. Moreover, since this pseudo-adhesive layer 19 is one which is incapable of repasting, it is impossible to falsify the contract document by repasting the first layer 11 and second layer 18. Accordingly, more reliable contract documents can be obtained.

### Second Embodiment

FIG. 2 shows a recording sheet 10B of the second embodiment and the positions of the heat-sensitive recording layer 14 and pressure-sensitive recording layer 13 in the first layer 11 are the opposite to those of the recording sheet 10A of the first embodiment and the pressure-sensitive recording layer 13 is arranged so as to contact the pseudo-adhesive layer 19.

Even with such a recording sheet 10B, it is possible to carry out the recording of letters and images by applying pressure or by heating from the outer surface side of the heat-sensitive recording layer 17 of the second layer 18 similarly to the recording sheet 10A of the first embodiment and to use effectively as a contract document or the like. However, since the heat transfer performance at the time of heat-sensitive recording on the heat-sensitive recording layer 14 of the first layer 11 is lower than that in the recording sheet 10A of the first embodiment, it is necessary to make the heat-sensitive recording layer 14 of the first layer 11 with higher thermal responsiveness.

### Third Embodiment

FIG. 3 shows a recording sheet 10C of the third embodiment, which is different from the recording sheet 10A of the first embodiment because the second layer 18 does not have a heat-sensitive recording layer and is constituted only from the second substrate layer 16.

When recording is carried out on the heat-sensitive recording layer 14 or pressure-sensitive recording layer 13 of the first layer 11 using such a recording sheet 10C by heating or applying pressure from the outer surface side of the second substrate layer 16, the recorded content cannot be visualized from outside at the time of recording if the second substrate layer 16 is not optically transparent. The content becomes visible only when the first layer 11 and second layer 18 are separated while having the pseudo-adhesive layer 19 as a boundary thereof. Accordingly, the sheet can be applied to various notifications which notify personal information that is not disclosed to a third party but only to a specific individual, or the like. Additionally, it also becomes possible to differentiate individual information; for example, heat-sensitive recording is used for the content of notification from the A section of an office while pressure-sensitive recording is used for the content of notification from the B section, on one single recording sheet 10C.

Moreover, since the pseudo-adhesive layer 19 does not allow repasting, it is possible for a specific individual to know, before confirming the content of notification, whether a third party has seen the content.

### Fourth Embodiment

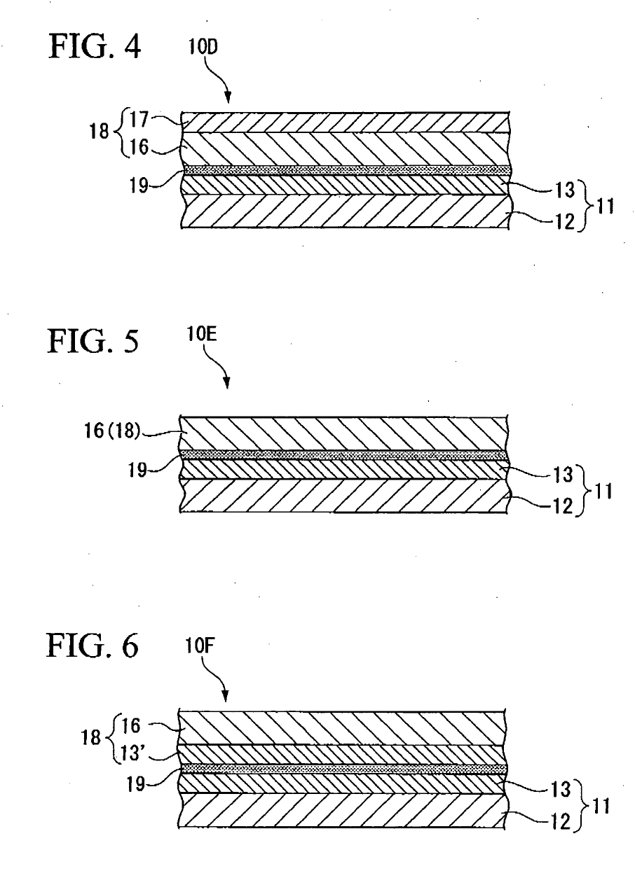

FIG. 4 shows a recording sheet 10D of the fourth embodiment, which is different from the recording sheet 10A of the first embodiment because the first layer 11 does not have a heat-sensitive recording layer.

When recording is carried out on the pressure-sensitive recording layer 13 of the first layer 11 using such a recording sheet 10D by applying pressure from the outer surface side of the heat-sensitive recording layer 17 of the second layer 18, the recorded content cannot be visualized from outside at the time of recording if the second substrate layer 16 or the heat-sensitive recording layer 17 is not optically transparent. The content becomes visible only when the first layer 11 and second layer 18 are separated while having the pseudo-adhesive layer 19 as a boundary thereof. In addition, by heating from outside the heat-sensitive recording layer 17 of the second layer 18, it is possible to perform heat-sensitive recording on the heat-sensitive recording layer 17 of the second layer 18 for the content, which needs visual confirmation in advance. The recording sheet 10D of this embodiment can also be applied to notifications which notify personal information that is not disclosed to a third party but only to a specific individual, or the like.

Moreover, since the pseudo-adhesive layer 19 does not allow repasting, it is possible for a specific individual to know, before confirming the content of notification, whether a third party has seen the content.

### Fifth Embodiment

FIG. 5 shows a recording sheet 10E of the fifth embodiment, which is different from the recording sheet 10A of the first embodiment because the first layer 11 nor second layer 18 has a heat-sensitive recording layer.

When recording is carried out on the pressure-sensitive recording layer 13 of the fist layer 11 using such a recording sheet 10E by applying pressure from the outer surface side of the second layer 18, in other words, the older surface side of the second substrate layer 16, the recorded content cannot be visualized from outside at the time of recording if the second substrate layer 16 is not optically transparent. The content becomes visible only when the fist layer 11 and second layer 18 are separated while having the pseudo-adhesive layer 19 as a boundary thereof.

Accordingly, the sheet in this case can also be applied to notifications which notify personal information that is not disclosed to a third party but only to a specific individual, or the like.

Moreover, since the pseudo-adhesive layer 19 does not allow repasting, it is possible for a specific individual to know, before confirming the content of notification, whether a third party has seen the content.

### Sixth Embodiment

FIG. 6 shows a recording sheet 10F of the sixth embodiment. In this embodiment, the first layer 11 where a pressure-sensitive recording layer (a layer capable of pressure-sensitive recording) 13 is formed on one face of the first substrate layer 12 and the second layer 18 where a pressure-sensitive recording inducing layer 13′ on one face of the second substrate layer 16 are laminated via the pseudo-adhesive layer 19. The pressure-sensitive recording layer 13 of the first layer 11 is arranged so as to be situated adjacent to the pressure-sensitive recording-inducing layer 13′ of the second layer 18 via the pseudo-adhesive layer 19. Unlike the cases of first to fifth embodiments, the pressure-sensitive recording layer 13 of the recording sheet 10F of this embodiment is one having a non-self-color developing property, which contains only developers and no color formers. The layer 13 of this embodiment develops colors due to pressure-welding with the pressure-sensitive recording inducing layer 13′, which contains only color formers and no developers, by pressure applied from the outer surface side of the second substrate layer 16.

The recording sheet 10F of this embodiment can be produced as follows.

Firstly, the first substrate layer 12 is prepared and on one surface thereof a coating liquid for the formation of the developer layer is coated and dried to form the pressure-sensitive recording layer 13 resulting in the production of the first layer 11. On the other hand, the second substrate layer 16 is prepared and on one surface thereof a coating liquid for the formation of the color former layer is coated and dried to form the pressure-sensitive recording inducing layer 13′ resulting in the production of the second layer 18.

The coating liquid for the formation of the pseudo-adhesive layer is then prepared and coated on the surface of the pressure-sensitive recording layer 13 of the first layer 11 or the pressure-sensitive recording inducing layer 13′ of the second layer 18 and dried after the first layer 11 and the second layer 18 are pasted together (wet lamination method).

For types of each of the substrate layers 12 and 16, preparation method of each coating liquid, coating method, coating amount, or the like, those shown in the first embodiment can be similarly selected.

According to the wet lamination method, since hardly any pressure is required for pasting the first layer 11 and second layer 18 together, like the cases of the first to fifth embodiments, background staining due to the color development of the pressure-sensitive recording layer 13 does not occur on the obtained recording sheet 10F.

Moreover, according to the wet lamination method, since only a small coating amount of the coating liquid for the formation of pseudo-adhesive layer is required and it is possible to form a highly thin pseudo-adhesive layer 19, the recording sheet 10F, which has a configuration like the one shown in the present embodiment and which is practicable, can be provided.

In other words, with the pseudo-adhesive layer 19 formed by the wet lamination method, even when it is present between the pressure-sensitive recoding layer 13 and pressure-sensitive recording inducing layer 13′, developers in the pressure-sensitive recording layer 13 and the color formers in the pressure-sensitive recording inducing layer 13′ can contact and react due to the pressure applied from the outer surface side of the second substrate layer 16 at the time of recording resulting in the favorable color development of the pressure-sensitive recording layer 13.

In addition, in this case, inorganic pigments may be added to the coating liquid for the formation of the pseudo-adhesive layer in order to enhance color developing property. When the coating liquid for the formation of the pseudo-adhesive layer containing inorganic pigments is used, the formed pseudo-adhesive layer 19 would be one with a small space around inorganic pigments. According to such a pseudo-adhesive layer 19, the developers in the pressure-sensitive recording layer 13 and the color formers in the pressure-sensitive recording inducing layer 13′ can favorably contact and react.

The color development of the pressure-sensitive recording layer will be difficult when another layer is present between the pressure-sensitive recording layer and pressure-sensitive recording inducing layer since the contact and reaction between the developers and color formers are inhibited. Accordingly, in the past, it was difficult to put a recording sheet with a configuration like the one in this embodiment where the first layer having a pressure-sensitive recording layer and the second layer having a pressure-sensitive recording inducing layer are laminated via a pseudo-adhesive layer to a practical use. For this reason, even when the first and second layers are used while being superimposed, in the application such as receipts, for example, it was impossible to completely adhere these layers via the pseudo-adhesive layer. Accordingly, adopted methods were limited only to the method to partially adhere the end parts of the first and second layers only, the method to form sprocket holes in the end parts of the first and second layers and fitting the pins of a paper feed roller therein to hold so that the first and second layers do not misalign, or the like. Handleability of such recording sheets was not favorable because of problems such as preseparation of adhered parts, likely misalignments of the first and second layers, or difficulties in making into roll forms. However, according to the recording sheet 10F of this embodiment, by adopting the wet lamination method, the first layer 11 and the second layer 18 can be completely adhered via the pseudo-adhesive layer 19 without preventing the color development of the pressure-sensitive recording layer 13. Accordingly, handleability thereof will be favorable since the problems of preseparation of adhered parts or likely misalignments of the first and second layers are unlikely to occur and it is also possible to make roll forms thereof.

Note that although this embodiment adopts a form where the pressure-sensitive recording layer 13 contains developers and the pressure-sensitive recording inducing layer 13′ contains color formers, the forms may be one where the pressure-sensitive recording layer 13 contains color formers and the pressure-sensitive recording inducing layer 13′ contains developers. Moreover, the pressure-sensitive recording layer 13 of this embodiment may further contain reactive dyes and developers for heat-sensitive recording and may be capable of both pressure-sensitive recording and heat-sensitive recording.

### Seventh Embodiment

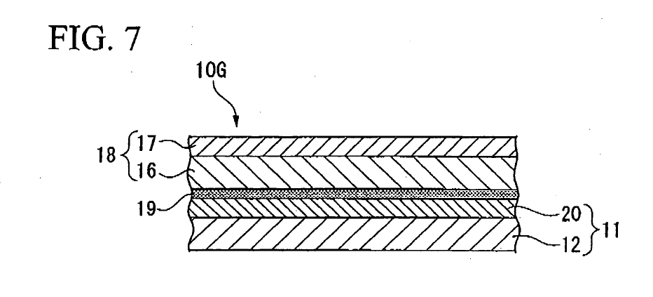

FIG. 7 shows a recording sheet 10G of the seventh embodiment which has, as a pressure-sensitive recording layer where pressure-sensitive recording is possible, a pressure-sensitive/heat-sensitive recording layer 20 where both pressure-sensitive and heat-sensitive recordings are possible. In other words, this embodiment is different from the first embodiment in only one point; i.e. the pressure-sensitive/heat-sensitive recording layer 20, which is a monolayer, is formed on one surface of the first substrate layer 12 instead of forming the pressure-sensitive recording layer 13 and heat-sensitive recording layer 14 separately. Even with such a recording sheet 10G, recording of letters, images, or the like can be carried out similarly to the recording sheet 10A of the first embodiment by applying pressure or by heating from the outer surface side of the heat-sensitive recording layer 17 of the second layer 18 and thus, the sheet can be effectively used for contract documents or the like.

The following may be used for the formation of such a pressure-sensitive/heat-sensitive recording layer 20: microcapsules which contain color formers for pressure-sensitive recording and developers; reaction dyes for heat-sensitive recording and developers; binders; and a coating liquid for the formation of the pressure-sensitive/heat-sensitive recording layer where pigments or additives which are used where necessary are dispersed in a dispersion medium such as water.

Moreover, the second layer may be formed solely from the second substrate layer in this embodiment also, as long as the monolayered pressure-sensitive/heat-sensitive recording layer 20 is formed on one surface of the first substrate layer 12.

### Others

Specific configurations of the recording sheets of the present invention are not limited to those in the first to seventh embodiments as long as the sheet is one where a second layer, which has at least a second substrate layer, is laminated on the recording layer side of a first layer, which has a first substrate layer and a recording layer capable of pressure-recording, by the wet lamination method via a pseudo-adhesive layer.

For example, it is possible to make the recorded information invisible from the outside even when these recording sheets are held against light by the following method: forming a shielding layer by printing patterns such as belts, reticulates, staggers, spots, letters, ground tints or the like or by pasting metal foil or metallized films.

Additionally, it may also be possible to make the information recorded on the heat-sensitive recording layer of the first layer visible from the outside by adopting, as the second substrate layer in the third embodiment, optically transparent materials like film substrates such as PET, PP, and PE or paper substrates such as glassine paper, for example. In this case, the second substrate layer functions as protection for the heat-sensitive recording layer. Moreover, in this case, it may also be possible to make a part of the information formed on the heat-sensitive recording layer invisible from the outside by forming a shielding layer by printing patterns such as belts, reticulates, staggers, spots, letters, ground tints or the like or by pasting metal foil or metallized films.

Furthermore, it is also possible to form a proposed section-line which penetrates the recording sheet in the thickness direction such as perforations or to carry out half-cut processing which does not penetrate in the thickness direction on arbitrary places of these recording sheets of each embodiment where necessary. In addition, it is also possible to provide arbitrary letters or images, for purposes other than shielding, on outer surfaces of the first and/or second substrate layers in these sheets.

Further, it is also possible to provide a layer between each layer for purposes such as controlling the extent of adherence between each layer. For example, it is possible to make the fit and second layers more readily separable by coating repellents such as silicon resin or polyethylene wax onto one surface or both surfaces of pseudo-adhesive layer to provide a repellent layer, or to provide a prime coating layer on the first or second substrate layer and then forming another layer thereon.

Particularly, by forming a known prime coating layer, which has pigments and adhesive agents as major components and which is conventionally used as the heat-sensitive recording material, it is possible to enhance color developing sensitivity of a heat-sensitive recording layer when formed on the prime coating layer. Examples of pigments of the prime coating layer which exert such an effect include pigments with high porosities such as silica and calcined kaolin and a greater effect can be achived by further making the first coating layer contain plastic pigments, hollow particles, foams, or the like therein. Furthermore, it is also possible to control the degree of adherence between an adhesive surface and the pseudo-adhesive layer by providing a partial printing section, which is linear, punctuate, or the like, in advance and changing the formation density of this printing section.

Moreover, it is also possible to form a known protective layer which has pigments and adhesive agents as major components and which is conventionally used as a heat-sensitive recording material on the heat-sensitive recording layer or the pressure-sensitive recording layer, which will be provided.

Furthermore, it is also possible to assign a higher function to the recording sheet of the present invention by the following usage: using the recording sheet of the present invention as pressure-sensitive adhesive paper, remoistening adhesive paper, or delayed tack paper by subjecting the back surface of the first substrate layer to coating processing using tackiness agents, remoistening adhesives, adhesives of delayed tack-type, or the like; or using the recording sheet of the present invention as the recording sheet where magnetic recording is also possible by forming a layer which is capable of magnetic recording (magnetic recording layer) on the back surface of the first substrate layer or on a part of the surface of the recording sheet.

### EXAMPLE

Although the present invention will be described in further detail below by showing Examples, the present invention is not limited to these Examples. In addition, “parts” and “%” in the Examples stand for “mass parts” and “mass %” respectively, unless otherwise stated.

### Example 1

The recording sheet of the first embodiment was produced as follows.

<Preparation of Heat-Sensitive Color-Developing Components>

(1) Preparation of Solution A (Dispersion of Leuco Dyes)

A composition composed of 20 parts of 3-di(n-butyl)amino-6-methyl-7-anilinofluoran, 5 parts of a 5% aqueous solution of methyl cellulose, and 15 parts of water was ground using a sand mill until the average particle diameter of 1.0 μm was achieved.

(2) Preparation of Solution B (Dispersion of Developers)

A composition composed of 20 parts of bis(3-allyl-4-hydroxyphenyl)sulfone, 5 parts of a 5% aqueous solution of methyl cellulose, and 15 parts of water was ground using a sand mill until the average particle diameter of 1.0 μm was achieved.

(3) Preparation of Solution C (Dispersion of Sensitizers)

A composition composed of 20 parts of 1,2-di(3-methylphenoxy)ethane, 5 parts of a 5% aqueous solution of methyl cellulose, and 15 parts of water was ground using a sand mill until the average particle diameter of 1.0 μm was achieved.

<Preparation of the Coating Liquid for the Formation of a Heat-Sensitive Recording Layer>

60 parts of a 30% silica dispersion (product name: Mizukasil® P-527 manufactured by Mizusawa Industrial Chemicals, Ltd.), 20 parts of solution A, 50 parts of solution B, 10 parts of solution C, 13 parts of an aqueous dispersion of zinc stearate (product name: Hydrin Z-7-30, solid component 31.5%, manufactwld by Chulyo Yushi Co., Ltd.), 40 parts of SBR latex (product name: L-1571, concentration 48%, manufactured by Asahi Kasei Corporation), and 40 parts of a 10% aqueous solution of silicon-modified polyvinyl alcohol (product name: R-1130, molecular weight 1700, manufactured by Kuraray Co., Ltd.) were mixed and stirred to obtain the coating liquid for the formation of the heat-sensitive recording layer.

<Preparation of First Layer>

Celkon paper [KS copy/bright, count: N50, color development: blue] manufactured by Oji Paper Co., Ltd. in which the pressure-sensitive recording layer with a self-color developing property is formed on the first substrate layer was used. The first layer was obtained by coating the abovementioned coating liquid for the formation of the heat-sensitive recording layer on the pressure-sensitive recording layer of the above celkon paper using a gravure coater so that the coated amount after drying is 4 g/m², and drying thereof to form a heat-sensitive recording layer. Note that the pressure-sensitive recording layer of the celkon paper used which has a self-color developing property has a monolayer structure and contains, as a color former, CVL (crystal violet lactone manufactured by Yamamoto Corporation. Co., Ltd.) which contains crystal violet lactone in microcapsules, and contains R-054-K (zinc-salicylate type manufactured by Sanko Chemical Industry Co., Ltd.) as a developer.

<Preparation of Recording Sheet>

An intermediate of the recording sheet composed of the first layer/pseudo-adhesive layer/second substrate layer was obtained as follows. A pseudo-adhesive agent (product name: Fultite FB131 (vinyl-acetate type adhesive agent), active ingredient 44%, manufactured by Mitsui Bussan Solvent and Coating Co., Ltd.) was coated on the heat-sensitive recording layer of the first layer using a gravure coater so that the coated amount after drying is 2 g/m², and without drying this pseudo-adhesive agent, pasting glassine paper (basis weight 25 g/m², density 0.92 g/cm³) as the second substrate layer 16 and thereafter drying the agent.

Subsequently, the abovementioned coating liquid for the formation of the heat-sensitive recording layer was coated using a gravure coater on the second substrate layer of this recording-sheet intermediate so that the coated amount after drying is 5 g/m², dried, and the heat-sensitive recording layer was formed to obtain the recording sheet composed of the first layer/pseudo-adhesive layer/second layer.

The adhesive strength between the first and second layers in the obtained recording sheet measured by the T-peel test was 180 mN/25 mm (peel rate 300 mm/min).

### Example 2

The recording sheet of Example 2 was obtained in the same way as that of Example 1 except that the celkon paper used in Example 1 was replaced with [KS copy/bright, count: N40, color development: black], manufactured by Oji Paper Co., Ltd.

The recording sheets obtained in each Example had no background staining and printing on each recording layer was also sharp and clear.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A recording sheet comprising:
a first layer having at least a first substrate layer and a recording layer, which is capable of pressure-sensitive recording;
a second layer having at least a second substrate layer; and
a pseudo-adhesive layer via which the second layer is laminated on the recording layer side of the first layer,
wherein the pseudo-adhesive layer is formed by wet lamination method.

2. The recording sheet according to claim 1, wherein the recording layer is a pressure-sensitive recording layer which contains a color former and a developer and having a self-color developing property.

3. The recording sheet according to claim 1,
wherein the recording layer is a pressure-sensitive recording layer, which contains one of a color former and developer and having a non-self-color developing property and also, the second layer further has a pressure-sensitive recording inducing layer, which contains the other of a color former and developer, and
wherein the pressure-sensitive recording layer and the pressure-sensitive recording inducing layer are arranged so that they are adjacent to each other via the pseudo-adhesive layer.

4. The recording sheet according to any one of claims 1 and 3, wherein at least one of the first layer and the second layer further has a heat-sensitive recording layer.

5. The recording sheet according to claim 1, wherein the recording layer is a pressure-sensitive/heat-sensitive recording layer which is capable of pressure-sensitive recording as well as heat-sensitive recording.

6. The recording sheet according to claim 5, wherein the second layer further has a heat-sensitive recording layer.
